(19) United States
(12) Patent Application Publication
(10) Pub. No.: US 2009/0192844 A1
(43) Pub. Date: Jul. 30, 2009

(54) AUTONOMIC BUSINESS PROCESS PLATFORM AND METHOD

(76) Inventors: Nithya Ramkumar, Bangalore (IN); Umakant Soni, Bangalore (IN); Akshay Mohan, Cambridge, MA (US); Amit Vikram, Bangalore (IN); T. K. Kurien, Bangalore (IN); Arundat Mercy Dasari, Bangalore (IN)

Correspondence Address: Global IP Services, PLLC, 198 F, 27th Cross, 3rd Block, Jayanagar, Bangalore, 560011, IN

(21) Appl. No.: 12/022,158

(22) Filed: Jan. 30, 2008

(51) Int. Cl. G06Q 10/00

(52) U.S. Cl. 705/7

(57) ABSTRACT

An automatic business process platform and method is disclosed. In one embodiment, a method includes monitoring systems, resources, persons, and/or processes, and controlling the systems, the resources, the persons, and/or the processes. The method may include diagnosing, an issue associated with the systems, the resources, the persons, and/or the processes, and providing advice to change at least one state of the systems, the resources, the persons, and/or the processes. The method may also include predicting at least one future state of the systems, the resources, the persons, and/or the processes. The method may further include learning to determine an association of at least one state of the systems, the resources, the persons, and the processes with at least one state of the systems, the resources, the persons, and the processes.

### FIELD OF THE INVENTION

The present invention relates to business processing, and more specifically to an autonomic business process platform and method.

### BACKGROUND

In the current state of the art, human intervention may be required at one or more instances to achieve business objectives for which a business process was initiated. Due to the need for human intervention, performance of a business process may be highly dependent on abilities of humans, making the business process prone to inefficiencies and errors. For these reasons, the business process may not be scalable and may not be repeatable in terms of performance. The foregoing issues may also add to costs in terms of human labor and high risk for a business process owner to execute.

### BRIEF DESCRIPTION OF THE DRAWINGS

Example embodiments are illustrated by way of example and not limitation in the figures of the accompanying drawings, in which like references indicate similar elements and in which:

FIG. 1 illustrates a business processing environment, including an autonomic business process platform, according to one embodiment.

FIG. 2 illustrates data provided to the autonomic business process platform of FIG. 1, according to one embodiment.

FIG. 3 illustrates current operational statuses of engines of the autonomic business process platform, according to one embodiment.

FIG. 4 illustrates multiple monitoring, execution, and management systems employing the autonomic business process platform, according to one embodiment.

FIG. 5 illustrates application of at least a portion of the autonomic business process platform across various methods of the demand management system of FIG. 4, according to one embodiment.

FIG. 6 illustrates application of at least a portion of the autonomic business process platform across various methods of the service level agreement (SLA) management system of FIG. 4, according to one embodiment.

FIG. 7 illustrates application of at least a portion of the autonomic business process platform across various methods of the quality control (QC) management system of FIG. 4, according to one embodiment.

FIG. 8 illustrates application of at least a portion of the autonomic business process platform across various stages of an accounts payable process, according to one embodiment.

FIG. 9 illustrates a flow chart representing functionality of the autonomic business process platform in the account payable process, according to one embodiment.

FIG. 10 illustrates a diagrammatic system view of a data processing system in which any of the embodiments disclosed herein may be performed, according to one embodiment.

FIG. 11 illustrates a process flow of generating the autonomic business process platform, according to embodiment.

Other features of the present embodiments will be apparent from the accompanying drawings and from the detailed description that follows.

### DETAILED DESCRIPTION

An autonomic business process platform and method is disclosed. In the following description, for purposes of explanation, numerous specific details are set forth in order to provide a thorough understanding of the various embodiments. It will be evident, however, to one skilled in the art that the various embodiments may be practiced without these specific details.

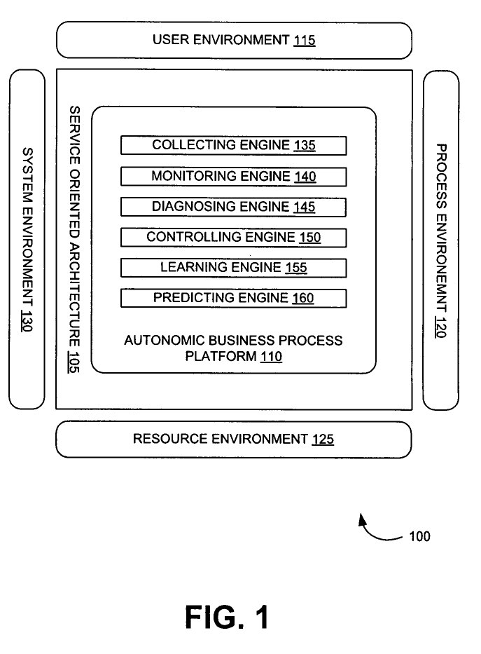

FIG. 1 illustrates a business processing environment 100, including an autonomic business process platform 110, according to one embodiment. Particularly, FIG. 1 illustrates a service oriented architecture (SOA) layer 105, the autonomic business process platform 110, external environments including a user environment 115, a process environment 120, a resource environment 125 and a system environment 130, and different engines of the autonomic business process platform 110 including a collecting engine 135, a monitoring engine 140, a diagnosing engine 145, a controlling engine 150, a learning engine 155 and a predicting engine 160.

The service oriented architecture (SOA) 105 refers to an architectural style and a design principle for application development and integration. The core concept in the SOA 105 includes a service, which is a self contained entity that performs a distinct business function. The autonomic business process platform 110 is a specialized SOA platform (e.g., using the architectural style) for building and delivering Business Process Outsourcing (BPO) services. In some embodiments, the autonomic business process platform 110 interacts with external environments including the user environment 115, the process environment 120, the resource environment 125 and the system environment 130 through the SOA layer 105.

The SOA integration layer 105 may provide standards-based integration capabilities and interaction of the autonomic business process platform 110 with the external environments. The user environment 115 may include people associated directly or indirectly with the autonomic business process platform 110 and associated combination of systems, resource, people and processes. For example, the user environment 115 includes all people necessary and sufficient for execution and management of the autonomic business process platform 110 and the associated combination of systems, resources, people and processes for providing business process outsourcing services. Further, the user environment includes all people that benefit from the execution and management of the autonomic business process platform 110 and the associated combination of systems, resources, people and processes for providing the business process outsourcing services.

The process environment 120 may include methods associated with the combination and/or multiple levels of systems, resources and people to satisfy a business objective. For example, the process environment 120 includes a business service environment and a business context in which the autonomic business process platform 110 is operating. The process environment 120 includes methods at various levels including those at atomic job step level, job level, multi job level, process level and business function level. In one example embodiment, the process environment 120 includes all methods necessary and sufficient for the execution and management of the autonomic business process platform 110 and the associated combination of systems, resources, people and processes for providing the business process outsourcing services.

The resource environment 125 may include all resources including shared utilities and infrastructure support in which the autonomic business process platform 110 operates. For example, the resource environment 125 includes all the resources necessary and sufficient for the execution and management of the autonomic business process platform 110 and the associated combination of systems, resources, people and processes for providing the business process outsourcing services.

The system environment 130 may include all systems that the autonomic business process platform 110 interacts with, directly or indirectly, such as technological systems and platforms (e.g., different ERP and legacy systems). In one example embodiment, the system environment 130 includes all the systems necessary and sufficient for the execution and management of the autonomic business process platform 110 and the associated combination of systems, resources, people and processes for providing the business process outsourcing services.

The user environment 115, the process environment 120, the resource environment 125 and the system environment 130 constitute a business environment that provides business objectives and overall constraints, requirements and expectations from the external environments and the autonomic business process platform 110. For example, the objectives, constraints, requirements and expectations are captured in agreements like service level agreements (SLAs).

In some embodiments, the autonomic business process platform 110 may include a first instruction set to monitor systems, resources, persons and/or processes. The autonomic business platform 110 may also include a second instruction set integrated with the first instruction set to control the systems, the resources, the persons and/or the processes. Further, the autonomic business process platform 110 may include a third instruction set integrated with the first instruction set and the second instruction set to diagnose an issue associated with the systems, the resources, the persons and/or the processes and to provide advice to change at least one state associated with the systems, the resources, the persons and/or the processes.

The autonomic business process platform 110 may include a fourth instruction set integrated with the first instruction set, the second instruction set and the third instruction set to predict a future state associated with the systems, the resources, the persons and/or the processes.

In addition, the autonomic business process 110 may include a fifth instruction set integrated with the first instruction set, the second instruction set, the third instruction set and the fourth instruction set to learn to determine an association of at least one state associated with the systems, the resources, the persons and/or the processes with at least one state of the systems, the resources, the persons and/or the processes.

The autonomic business process platform 110 may further include a sixth instruction set integrated with the first instruction set, the second instruction set, the third instruction set, the fourth instruction set and the fifth instruction set to collect, from a source(s), data associated with at least one state of the systems, at least one state of the resources, at least one state of the persons and at least one state of the processes. For example, the autonomic business process platform 110 is associated with multiple monitoring, execution and/or management systems.

In one embodiment, the different methods such as monitor, collect, predict, diagnose, control and learn associated with the systems, the resources, the persons and/or the processes are accomplished by employing engines of the autonomic business process platform 110.

In accordance with the one or more embodiments described above, the collecting engine 135 may collect, from different sources, data associated with at least one state of the systems, at least one state of the resources, at least one state of the persons and/or at least one state of the processes. The monitoring engine 140 may monitor the systems, the resources, the persons and/or the processes. The diagnosing engine 145 may diagnose, an issue associated with the systems, the resources, the persons, and the processes. In one embodiment, the diagnosing engine 145 may also provide advice to change at least one state of the systems, the resources, the persons and/or the processes.

The controlling engine 150 may control the systems, the resources, the persons, and the processes. The learning engine 155 may learn to determine an association of at least one state of the system, the resource, the person and/or the process with at least one state of the system, the resource, the person and/or process. The predicting engine 160 may predict a future state of the systems, the resources, the persons and the processes.

Alternatively, various other components, and/or various implementations of components, may be associated with various aspects of the autonomic business process platform 110.

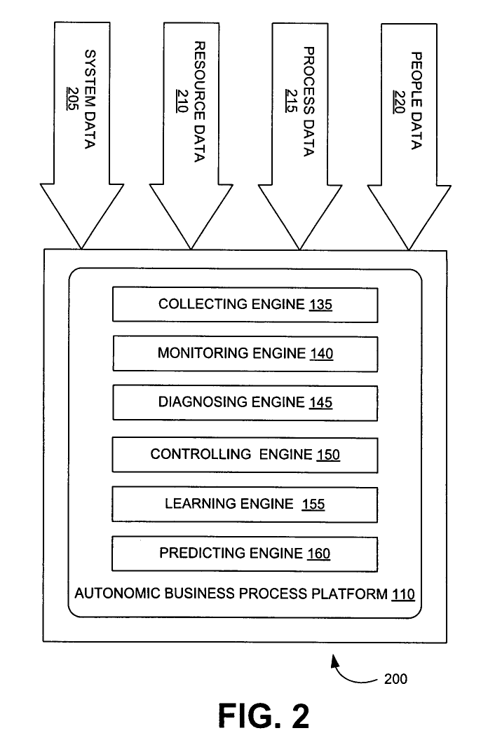

FIG. 2 illustrates data provided to the autonomic business process platform 110 of FIG. 1, according to one embodiment. Particularly, FIG. 2 illustrates the collecting engine 135, the monitoring engine 140, the diagnosing engine 145, the controlling engine 150, the learning engine 155, the predicting engine 160, system data 205, resource data 210, process data 215 and people data 220.

In some embodiments, the data includes inputs, metrics and/or measurements associated with a state of a combination of systems, resources, people and processes. For example, the combination includes at least one system, at least one resource, at least one person, and at least one process and the state includes all or part of the data that is necessary and sufficient to uniquely identify, characterize and distinguish one combination from another. The state also includes but is not limited to the set of actions, events, messages and outcomes associated with the combination.

The system data 205 may be a set of inputs, measurements and/or metrics associated with different systems involved directly or indirectly in the execution and management of the combination of systems, resources, people and processes and the autonomic business process platform 110. In one embodiment, the system data 205 is provided to the autonomic business process platform 110 by the system environment 130. The system data 205 which may be part of the various inputs to the different functionalities of the automatic business process platform 110 may be collected at various levels of the system.

The resource data 210 may be a set of inputs, measurements and/or metrics associated with the state of various resources involved directly or indirectly in the execution and management of the combination of systems, resources, people and process and the autonomic business process platform 110. The resource data is provided to the autonomic business process platform 110 by the resource environment 125. The resource data 210 which may be part of the various inputs to the different functionalities of the autonomic business process platform 110 may be collected at various levels of the resource.

The process data 215 may be a set of inputs, measurements and/or metrics associated with different processes associated with the state of various processes that are directly or indirectly part of the execution and management of the combination of systems, resources, people and processes and the autonomic business process platform 110. In one embodiment, the process data 215 is provided to the autonomic business process platform 110 by the process environment 120. The process data 215 which may be part of the various inputs to the different functionalities of the automatic business process platform 110 may be collected at various levels of the system such as the atomic job step level, job level, multi job level, process level and business function level. Further, the process data 215 may include business context of the process environment 120 including SLAs.

The people data 220 may be a set of inputs, metrics and/or measurements related to people who are directly or indirectly part of the execution and management of the combination of systems, resources, people and process and the autonomic business process platform 110 and/or the people who are influenced by the execution and management. The people data 220 are provided to the autonomic business process platform 110 by the user environment 115. The people data 220 which may be part of the various inputs to the different functionalities of the automatic business process platform 110 may be collected at various levels of the user environment 115.

In some embodiments, data about a current state associated with a specific combination of the systems, the resources, the processes and the people are collected by the collecting engine 135 of the autonomic business process platform 110 from different sources. The data collected may be part or all of the collected data to optimally perform as specified by the process environment 150 in which the autonomic business process platform 110 operates. For example, these data may be real-time, periodic, non-periodic, local or global process data and may be used by the user environment 115, the process environment 120, the resource environment 125 and the system environment 130. Further, the data may include aggregated or individual elements and is disseminated to the systems and the people involved in the execution and management of the combination including but not limited to the monitoring engine 140, the diagnosing engine 145, the controlling engine 150, learning engine 155 and the predicting engine 160.

Further, based on the data and metrics, the autonomic business process platform 110 may monitor a system, a resource, a process, and/or a person. The monitoring engine 140 compares the current state associated with the specific combination of system, the resource, the process and the person with a desired state associated with a specific combination of the system, the resource, the process and the person, specified by the process environment 120. For example, the monitoring engine 140 uses input from the collecting engine 135 to compare specific variables characterizing the state against predetermined thresholds of performance.

Further, the monitoring engine 140 may compare variables based on requests received from other engines of the autonomic business platform 110. The comparison of the different states indicates performance of the specific combination of the systems, the resources, the processes and the persons. The monitoring may be part or all of the necessary and sufficient monitoring to determine if the combination is performing optimally as specified by the process environment 120, in which the autonomic business process platform 110 operates. This data can be disseminated to the different systems and people involved in the execution and management of the processes including but not limited to the diagnosing engine 145, the controlling engine 150, the learning engine 155, and the predicting engine 160. The comparisons feed into the controlling engine 150 to determine if the controlling engine 150 is executing and managing the combination as per the process environment 120. In one embodiment, the diagnosing engine 145 takes inputs from the comparisons to identify positive and negative performances of the systems, the resources, the processes and/or the persons. Also, the comparison feeds into the learning engine 155 and the predicting engine 160 to determine associations between various states of the combination and to predict future states of the combination.

For example, the diagnosing engine 145 may determine reasons for occurrence of a specified state associated with a specific combination of systems, resources, people and processes, especially those within control of the autonomic business process platform 110. In other words, the diagnosing method is performed to determine the cause for the current combination performance as specified by the business environment in which the autonomic business process platform 110 operates. The diagnosing is part or all of the diagnosing necessary and sufficient to determine the cause for the current combination performance as specified by the business environment in which the autonomic business process platform 110 operates.

In some embodiments, the diagnosing engine 145 determines whether different systems, resources, processes and people are performing as per the requirements of the business environment. For example, the diagnosing engine 145 uses inputs from the collecting engine 135 and the monitoring engine 140 for the above determination. If it is determined that the performance is under par, corrective actions are taken. If it is determined that the performance is above par, cause of the increased efficiency is identified so that the identified causes can be repeated in the future. In one embodiment, the diagnosing engine 145 may use additional inputs from the learning engine 155 and the predicting engine 160 to improve upon the process of diagnosing.

Further, the outcome from the diagnosis process is disseminated to different engines of the autonomic business process platform 110. For example, the controlling engine 150 feeds on the diagnosis to help determine actions needed to execute and manage the autonomic business platform 110 as per business environment requirements. Also, the learning engine 155 and the predicting engine 160 use the diagnosis to determine associations between different states and to better predict future states associated with the system, the resource, the process and/or the people.

The controlling engine 150 performs actions needed for a specific combination of the system, the resource, the process and/or the people to attain a desired state. The controlling is part or all of the controlling necessary and sufficient to determine the cause for the current combination performance as specified by the business environment in which the autonomic business process platform 110 operates. In some embodiments, the collecting engine 135 and the monitoring engine 140 provides input to determine whether the combination performs as per the business environment requirements. Further, the diagnosing engine 145 may provide reasons for the combination to be in its current state.

The learning engine 155 may provide a set of actions to the controlling engine 150 based on associations of past data, actions and/or outcomes that can enable change in the combination from the current state to a desired state. The controlling engine 150 may use the inputs from the learning engine 155 to determine multiple sets of actions that allows the combination of the system, the resource, the process and/or the people to reach the desired state. The predicting engine 160 may simulate a set of actions determined by the controlling engine 150 to determine the effect of each set of actions. Further, the combined set of inputs can be used by the controlling engine 150 to determine the final set of actions to be executed to manage and maintain combination performance, and proactively correct deviations in the combination performance.

The learning engine 155 may determine associations between states of a combination of systems, resources, people and processes to help the processes perform as per business environment requirements. The learning is part or all of the learning necessary and sufficient to determine the cause for the current combination performance as specified by the business environment in which the autonomic business process platform 110 operates. The learning engine 155 uses data about the past combination performance. The collecting engine 135 and monitoring engine 140 provides input to determine the current state of the combination, the current combination performance and the current set of actions being performed. The diagnosing engine 145 may provide reasons for the current combination performance. The predicting engine 160 can provide the learning engine 155 with possible states against which the learning engine 155 may test its associations. These inputs may be used by the learning engine 155 to determine associations of the past states that can lead to better combination performance.

These sets of associations can feed into the controlling engine 150 to determine the set of actions to be executed to maintain the desired level of combination performance and proactively change state to correct combination deviations. These also feed into the predicting engine 160 to improve combination simulation and by the diagnosing engine 145 to determine the most probable diagnosis.

The predicting engine 160 may do a simulation to determine a future state of the combination of systems, resources, processes and/or people and use the predicted outcome to recommend actions for improved combination performance. The predicting is part or all of the predicting necessary and sufficient to determine the cause for the current combination performance as specified by the business environment in which the autonomic business process platform 110 operates. The collecting engine 135 and monitoring engine 140 provide input to the predicting engine 160 to determine the current state of the combination, the current combination performance and the current set of actions being performed. The diagnosing engine 145 may provide reasons for the current combination performance. The learning engine 155 may provide the predicting engine 160 with associations of past states that can lead to an improved prediction. These inputs are then used to predict the future state of the combination. These sets of predictions can feed into the controlling engine 150 to determine the set of actions to be executed to maintain the desired level of combination performance and to proactively change state to correct process deviations. These also feed into the learning engine 155 to determine correct associations and into the diagnosing engine 145 to determine the most probable diagnosis.

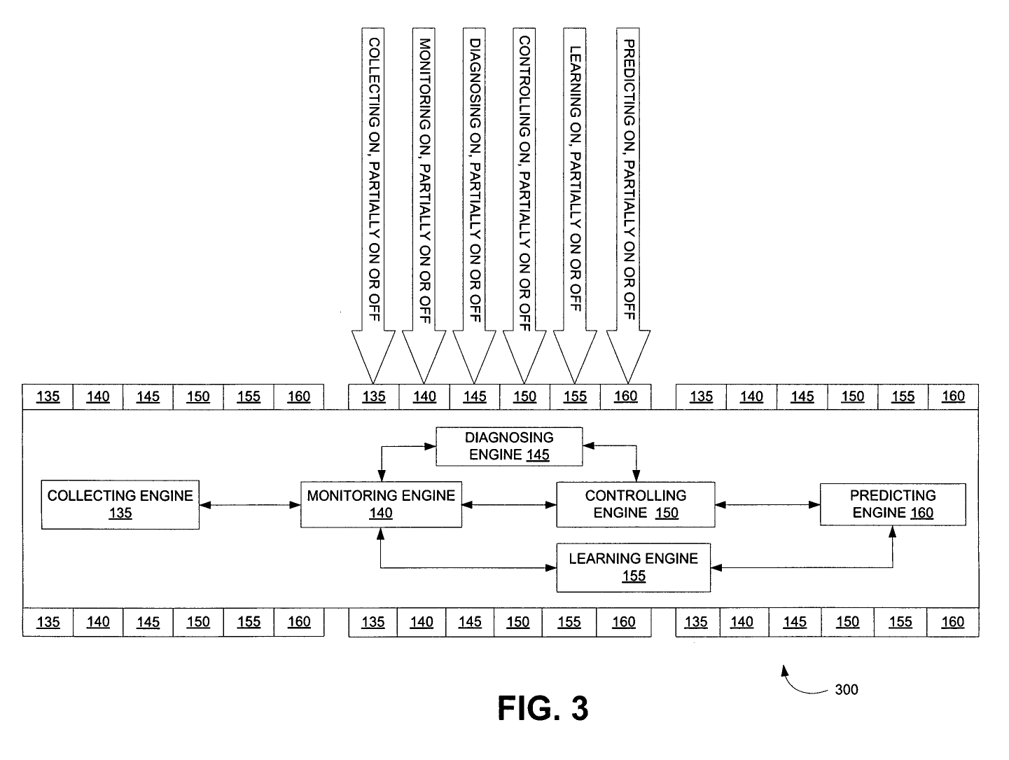

FIG. 3 illustrates current operational statuses of the engines of the autonomic business process platform 110, according to one embodiment. Particularly, FIG. 3 illustrates the collecting engine 135, the monitoring engine 140, the diagnosing engine 145, the controlling engine 150, the learning engine 155, the predicting engine 160 and inputs to determine whether the functions of collecting, monitoring, diagnosing, controlling, learning and predicting are activated.

The autonomic business process platform 110 may dynamically turn on completely or partially, or turn off a subset of the engines of the autonomic business process platform 110 for a particular combination of the systems, the resources, the people and the processes. The dynamic implementation of engine(s) by the autonomic business process platform 110 for collecting, monitoring, diagnosing, controlling, predicting and/or learning typically depends on nature of the systems, the resources, the people and the processes to be employed.

The autonomic business platform 110 may be employed to provide diverse functionalities and accomplish different operations within a single environment or different environments. Further, the autonomic business process platform 110 may enable functionality at various levels of the systems, the resource, the people and the processes. The functionality of the autonomic business process platform 110 allows management of a combination of the systems, the resources, the people and the processes in a way that the combination is according to context and objectives defined by the business environment.

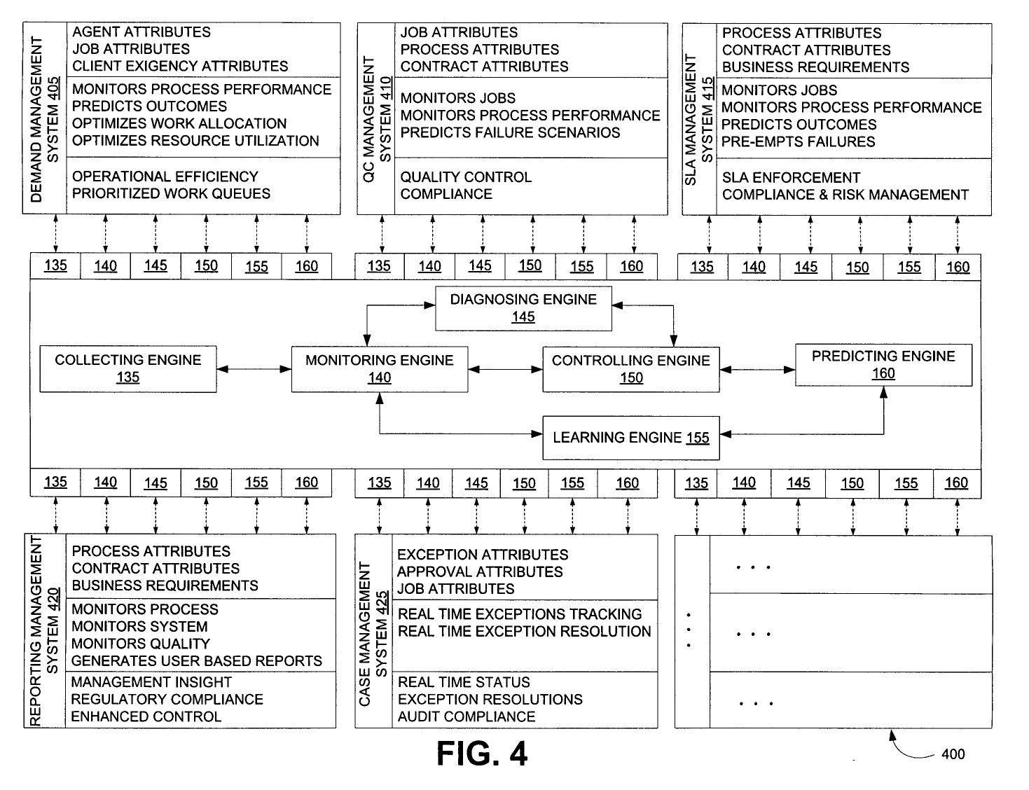

FIG. 4 illustrates multiple monitoring, execution, and management systems employing the autonomic business process platform 110, according to one embodiment. Particularly, FIG. 4 illustrates inputs, functional units and outcome or benefits associated with the multiple monitoring, execution, and management systems that include a demand management system 405, a QC management system 410, an SLA management system 415, a reporting management system 420 and a case management system 425.

As illustrated in FIG. 4, functionality at meta-process level is accomplished by employing the engine(s) of the autonomic business process platform 110. For example, as part of the demand management system 405, all the six engines of the autonomic business process platform 110 take inputs of agents attributes, job attributes, client exigency attributes to perform the actions of monitoring process performance, predicting demand outcomes, optimizing work allocation and optimizing resource utilization. As a result, operational efficiency and prioritized work queues are attained in the demand management system 405. The level of functionality in the demand management system 405 is determined by the business environment and is based on the specific combination of the six engines of the autonomic business process platform 110.

As a part of the quality control (QC) management system 410, the six engines take inputs of job attributes, process attributes and contract attributes to perform the actions of monitoring jobs, monitoring process performance and predicting failure scenarios. The outcome of employing the autonomic business process platform 110 is quality control and compliance. The level of functionality provided in the QC management system 410 is determined by the business environment and is based on the specific combination of the six engines of the autonomic business process platform 110.

When the autonomic business process platform 110 is employed in the SLA management system 415, the six engines take inputs of process attributes, contract attributes and business requirements to perform the actions of monitoring jobs, monitoring process performance, predicting outcomes and pre-empting failures. These actions result in SLA enforcement, compliance and risk management. The level of functionality provided in the SLA management system 415 is determined by the business environment and is based on the specific combination of the six engines of the autonomic business process platform 110.

As part of the reporting management system 420, the six engines take inputs of process attributes, contract attributes and business requirements to perform the actions of monitoring process, monitoring system, monitoring quality and generating user based reports. As a result, management insight, regulatory compliance and enhanced control are enabled in the reporting management system 420. The level of functionality provided in the reporting management system 420 is determined by the business environment and is based on the specific combination of the six engines of the autonomic business process platform 110.

As part of the case management system 425, the six engines take the inputs of exception attributes, approval attributes and job attributes to perform the actions of real time exception tracking and resolution. These actions result in audit compliance, exception resolution and real time status. The level of functionality provided in the case management system 425 is determined by the business environment and is based on the specific combination of the six engines of the autonomic business process platform 110.

In one embodiment, the management operations are accomplished by employing the engine(s) of the autonomic business process platform 110. The management operations may include one or more business processes associated with production of goods and/or services, and involve responsibility of ensuring that business operations are efficient and effective. The management operations may also include management of resources, distribution of goods and/or services to customers, analysis of queue systems, and/or may involve substantial measurement and analysis of internal processes.

FIG. 4 illustrates that the engines associated with the autonomic business process platform 110 may be employed to accomplish varied and different operations within a single environment or differing environments. One or more of the engines of the autonomic business process platform 110 may be employed to function at the different workflow levels to result in a scalable, repeatable and/or cost efficient automatic business process.

In some embodiments, the autonomic business process platform 110 (e.g., through the different engines) may enable selection of services and/or functions required for a given customer. Specific customer requirements may be configured and the business process may be customized to meet the specific requirements of the customers.

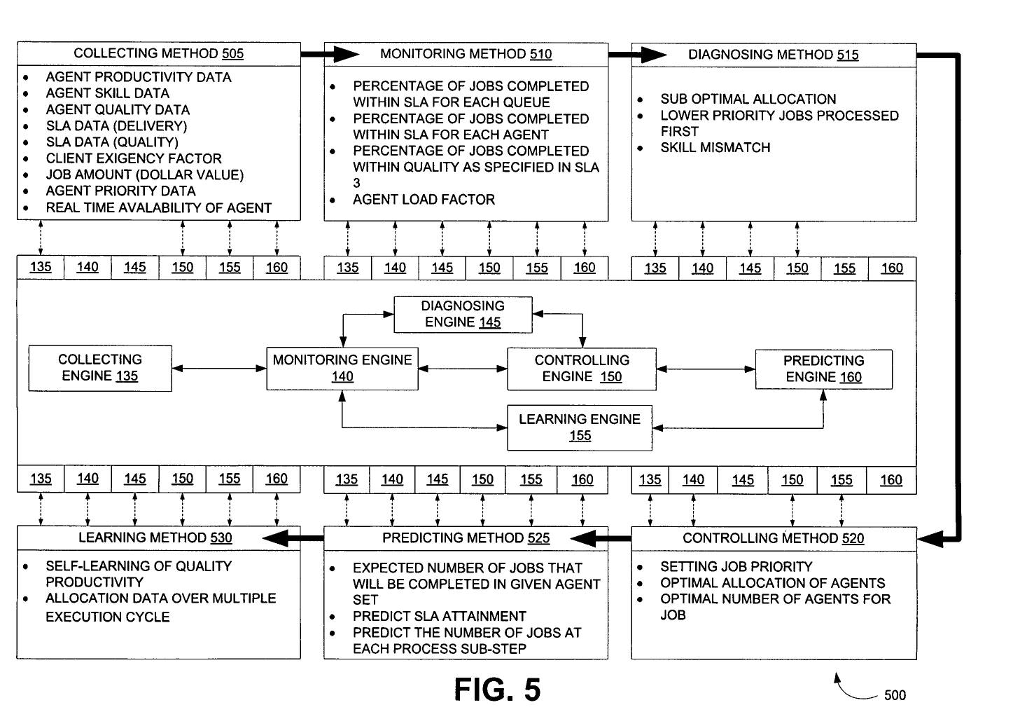

FIG. 5 illustrates application of at least a portion of the autonomic business process platform 110 across various methods that are part of the demand management system 405 of FIG. 4, according to one embodiment. Particularly, FIG. 5 illustrates different methods that are part of the demand management system 405 such as a collecting method 505, a monitoring method 510, a diagnosing method 515, a controlling method 520, a predicting method 525 and a learning method 530. In one embodiment, the different methods of the demand management system 405 may be accomplished by employing one or more of the engine(s) of the autonomic business process platform 110.

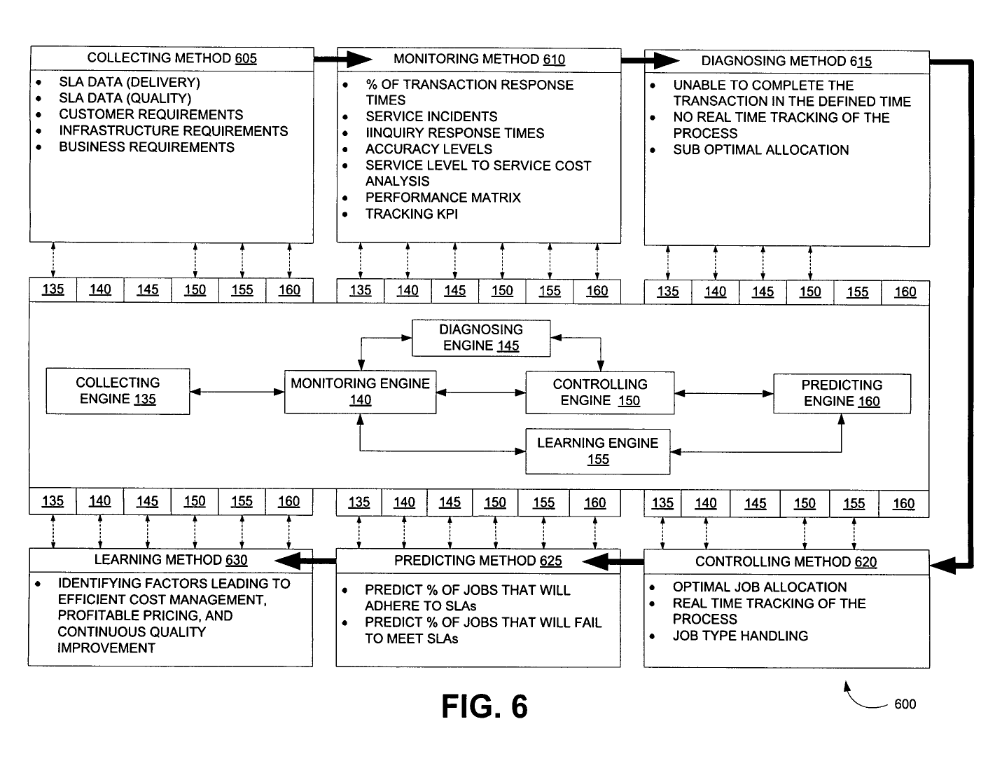

FIG. 6 illustrates application of at least a portion of the autonomic business process platform 110 across various methods that are part of the SLA management system 415 of FIG. 4, according to one embodiment. Particularly, FIG. 6 illustrates different methods of the SLA management system 415 such as a collecting method 605, a monitoring method 610, a diagnosing method 615, a controlling method 620, a predicting method 625 and a learning method 630. In one embodiment, the different methods of the SLA management system 415 may be accomplished by employing any of the engine(s) of the autonomic business process platform 110.

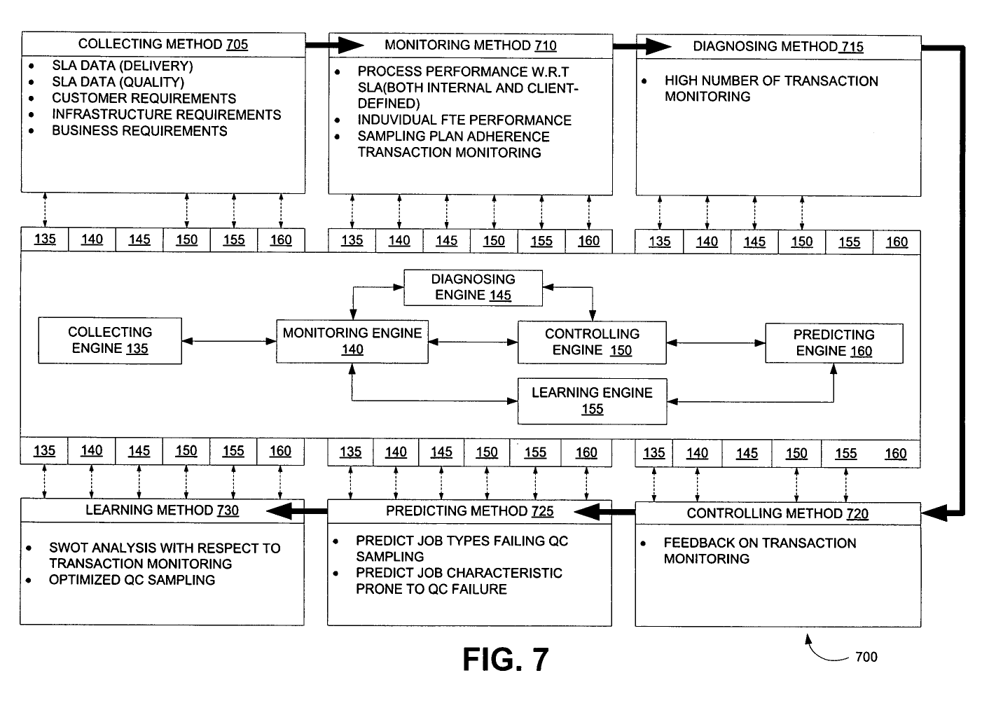

FIG. 7 illustrates application of at least a portion of the autonomic business process platform 110 across various methods that are part of the QC management system 410 of FIG. 4, according to one embodiment. Particularly, FIG. 7 illustrates different methods of the QC management system 410 such as a collecting method 705, a monitoring method 710, a diagnosing method 715, a controlling method 720, a predicting method 725 and a learning method 730. In one embodiment, the different methods of the QC management system 410 may be accomplished by employing any combination of the engine(s) of the autonomic business process platform 110.

The following description is explained in detail with respect to FIGS. 5, 6 and 7. The collecting method of monitoring, execution and management systems associated with the autonomic business process platform 110 may be accomplished using the collecting engine 135 of the autonomic business process platform 110. The collecting method may be the demand management system collecting method 505, the SLA management system collecting method 605 and the QC management system collecting method 705. The collecting is part or all of the collecting necessary and sufficient to optimally perform the functionality under consideration and its associated context as specified by the business environment. In some embodiments, the collecting engine 135 collates data from various sources associated with current state associated with a specific combination of systems, resources, people and processes. For example, the collecting engine 135 accomplishes demand management system collecting method 505 through collating sample inputs that are required to perform demand management functionality as a part of the demand management system 405. For example, the sample inputs collected for performing the demand management functionality may include agent productivity data, agent skill data, agent quality data, agent priority data, real time availability of the agent, SLA delivery data, SLA quality data, client exigency factor and job amount.

Further, sample inputs that can be collected by the collecting engine 135 (e.g., to accomplish the SLA management system collecting method 605) to perform the SLA management functionality as a part of the SLA management system 415 may include SLA delivery data, SLA quality data, customer requirements, infrastructure requirements and business requirements. Further, the collecting engine 135 collates sample inputs to perform the QC management functionality as part of the QC management system 410 which includes SLA delivery data, SLA quality data, customer requirements, infrastructure requirements and business requirements. In some embodiments, the inputs collected to perform the SLA management functionality can be used in a different context for QC management. The collected data can be disseminated to the different systems and people involved in the monitoring, execution and management of the process including but not limited to the monitoring engine 140, the diagnosing engine 145, the controlling engine 150, the learning engine 155 and the predicting engine 160.

Further, the monitoring method of the monitoring, execution and management systems associated with the autonomic business process platform 110 may be accomplished using the monitoring engine 140 of the autonomic business process platform 110. For example, the monitoring method may include the demand management system monitoring method 510, the SLA management system monitoring method 610 and the QC management system monitoring method 710. The monitoring is part or all of the monitoring necessary and sufficient to determine if the combination is performing optimally as specified by the business environment in which the autonomic business process platform 110 operates.

For example, the sample comparisons (e.g., obtained through performing the demand management system monitoring method 510) that the monitoring engine 140 can provide (e.g., for the demand management functionality as part of the demand management system 405) are percentage of jobs completed within SLA for each queue, percentage of jobs completed within SLA for each agent, percentage of jobs completed within quality as specified in the SLA and the agent load factor.

Similarly, sample comparisons that the monitoring engine 140 upon accomplishing the SLA management system monitoring method 610 can provide for the SLA management functionality as part of the SLA management system 415 are, percentage of transaction response times, service incidents, inquiry response times, accuracy levels of jobs, and tracking of key performance indicators.

In addition, the monitoring engine 140 can provide sample comparisons for the QC management functionality as part of the QC management system 410 as a result of the QC management system monitoring method 710. The sample comparisons may include the process performance as compared to the predetermined SLA, the performance of the individual agents and the adherence of the process to the sampling plan for quality check.

Further, this data (e.g., obtained through sample comparisons) can be disseminated to the different systems and people involved in the execution and management of the process including but not limited to the diagnosing engine 145, the controlling engine 150, the learning engine 155 and the predicting engine 160.

The diagnosing method of the monitoring, execution and management systems associated with the autonomic business process platform 110 may be accomplished using the diagnosing engine 145 of the autonomic business process platform 110. The diagnosing is part or all of the diagnosing necessary and sufficient to determine if the combination is performing optimally as specified by the business environment in which the autonomic business process platform 110 operates. The diagnosing method may be the demand management system diagnosing method 515, the SLA management system diagnosing method 615 and the QC management system diagnosing method 715.

It can be noted that, the diagnosing engine 145 uses the input from the collecting engine 135 and the monitoring engine 140 to determine if the combination is performing as per the requirements of the business environment.

For example, sample reasons that the diagnosing engine 145 can provide for the demand management functionality as part of the demand management system 405 if the process is underperforming are, sub optimal allocation, lower priority jobs being processed first and skill mismatch. Further, sample reasons that the diagnosing engine 145 can provide for the SLA management functionality as part of the SLA management system 415 if the process is underperforming are, inability to complete the specific job in the defined time and sub optimal allocation of jobs to agents. In addition, sample reasons that the diagnosing engine 145 can provide for the QC management functionality as part of the QC management system 410 if the process is underperforming is decreased productivity due to the high number of jobs and transactions being monitored and the like.

In some embodiments, the causes determined about the combination performance can be disseminated to the different systems and people involved in the execution and management of the combination including the controlling engine 150, the predicting engine 160 and the learning engine 155.

The controlling method of the monitoring, execution and management systems associated with the autonomic business process platform 110 may be accomplished using the controlling engine 150 of the autonomic business process platform 110. For example, the controlling method may be the demand management system controlling method 520, the SLA management system controlling method 620 and the QC management system controlling method 720. Further, the controlling is part or all of the controlling necessary and sufficient to determine if the combination is performing optimally as specified by the business environment in which the autonomic business process platform 110 operates.

The controlling engine 150 may perform actions needed for the specific combination of systems, resources, people and processes to reach the desired state or become as close to the desired state as possible.

For example, sample actions that the controlling engine 150 can decide to maintain demand management performance as part of the demand management system 405 are, setting job priority, allocation of agents with a specific skill for the job. In addition, sample actions that the controlling engine 150 can decide to maintain SLA management performance as part of the SLA management system 415 are, actions that result in optimal job allocation to agents with the correct skill level and real time tracking of the process to ensure SLA adherence. Further, sample actions that the controlling engine 150 can decide to maintain QC management performance as part of the QC management system 410 are, actions that result in optimal QC sampling and provide feedback on transaction monitoring.

The predicting method of the monitoring, execution and management systems associated with the autonomic business process platform 110 may be accomplished using the predicting engine 160 of the autonomic business process platform 110. The predicting method may be the demand management system predicting method 525, the SLA management system predicting method 625 and the QC management system predicting method 725. For example, the predicting is part or all of the predicting necessary and sufficient to determine if the combination is performing optimally as specified by the business environment in which the autonomic business process platform 110 operates. In some embodiments, the predicting engine 160 may perform a process simulation to determine a future state of a combination of systems, resources, people and processes and use the predicted outcome to recommend actions for improved combination performance.

For example, sample predicted outcomes that the predicting engine 160 can predict as part of the demand management functionality, as part of the demand management system 405 are, the expected number of jobs that will be completed and the expected number of jobs at each process sub step. Further, sample predicted outcomes that the predicting engine 160 can predict as part of the SLA management functionality, as part of the SLA management system 415 are, the percentage of jobs that will adhere to the SLA and the percentage of jobs that will fail to meet the SLA. In addition, sample predicted outcomes that the predicting engine 160 can predict as part of the QC management functionality, as part of the QC management system 410 are, to determine job types that frequently fail QC sampling to restrict quality control only on specific job types.

The learning method of the monitoring, execution and management systems associated with the autonomic business process platform 110 may be accomplished using the learning engine 155 of the autonomic business process platform 110. The learning method may be the demand management system learning method 530, the SLA management system learning method 630 and the QC management system learning method 730. The learning is part or all of the learning necessary and sufficient to determine if the combination is performing optimally as specified by the business environment in which the autonomic business process platform 110 operates. In some embodiments, the learning engine 155 may determine associations between the states of a combination of systems, resources, people and processes to help the combination performance be as per the business environment.

Sample learning that the learning engine 155 can develop as part of the demand management functionality, as part of the demand management system 405 are, associations that lead to optimal allocation over multiple execution cycles and learning of quality productivity. Further, sample learning that the learning engine 155 can develop as part of the SLA management functionality, as part of the SLA management system 415 are, associations that lead to efficient cost management, profitable pricing and continuous quality improvement. Additionally, sample learning that the learning engine can develop as part of the QC management functionality, as part of the QC management system 410 are, associations that lead to an optimized QC sampling by during a strength, weaknesses, opportunities and threat (SWOT) analysis with respect to transaction monitoring.

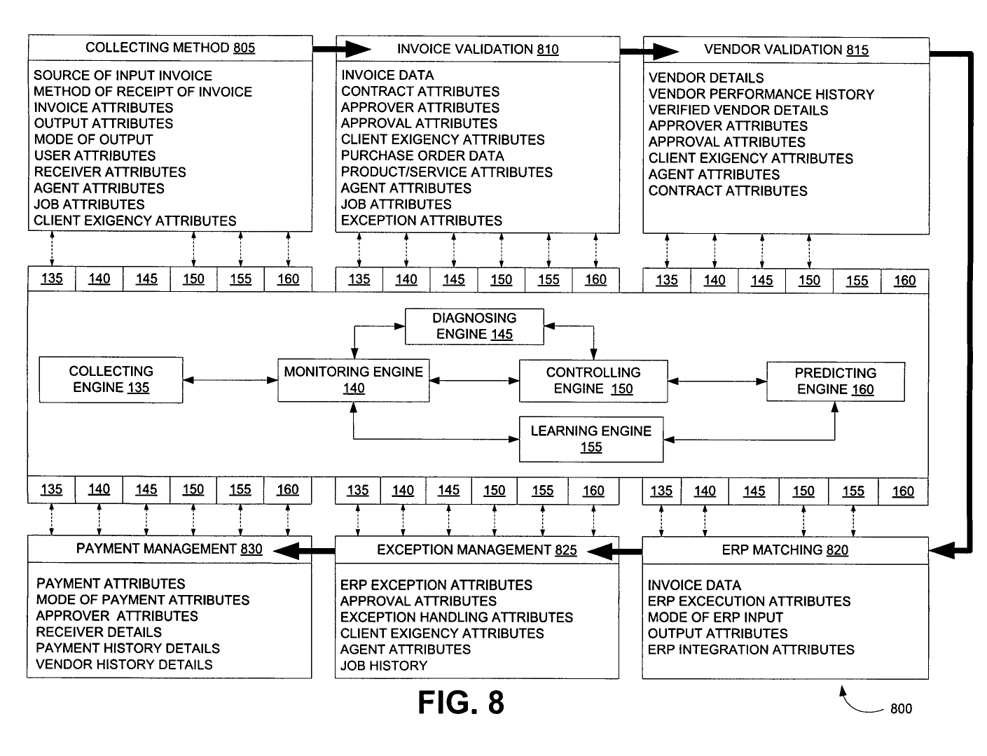

FIG. 8 illustrates application of at least a portion of the autonomic business process platform 110 across various stages of an accounts payable process, according to one embodiment. Particularly, the accounts payable process may include sub-processes of invoice receipt and handling 805, invoice validation 810, vendor validation 815, enterprise resource planning (ERP) matching 820, exception management 825 and payment management 830 as illustrated in FIG. 8. Accounts payable process may identify capture and pay liabilities of the company. Accounts payable process is a time-sensitive function and may lead to real costs as opportunity costs to the company. In one embodiment, the accounts payable process exemplifying the process environment may be using the autonomic business process platform 110 to provide a business process outsourcing service.

Sub-process invoice receipt and handling 805 may be a process of receiving and collating invoices from different vendors. The data may include source of input of an invoice, method of receipt of an invoice, invoice attributes, input attributes, output attributes, mode of output, user attributes, receiver attributes, agent attributes, job attributes and client exigency attributes. Furthermore, the sub-process invoice-receipt and handling 805 may be carried out by employing any combination of the six engines of the autonomic business process platform 110 based on the level of functionality needed as determined by the system, resource, user and process environment.

Sub-process invoice validation 810 may be a process of validating information presented on invoices and supporting documents, and identifying any data inaccuracy and/or inadequacy issues. For example, invoice data, contract attributes, approver attributes, approval attributes, client exigency attributes, purchase order data, product and/or service attributes, agent attributes, job attributes and exception attributes included in the invoices are validated by comparison with the data available within the organization. For example, the quantity of product supplied through the invoice is compared to the quantity of the product ordered through the corresponding purchase order placed with the vendor. Furthermore, the sub-process invoice validation 810 may be carried out by employing any combination of the six engines of the autonomic business process platform 110 based on the level of functionality needed as determined by the system, resource, user and process environment.

Sub-process vendor validation 815 may validate vendor information as per the information available on various systems. For example, the vendor information includes vendor details, vendor performance history, verified vendor details, approver attributes, approval attributes, client exigency attributes, agent attributes and contract attributes. Further, the vendor validation process 815 may validate authorization of the vendor to send the invoice for the goods and/or services received. Furthermore, the sub-process vendor validation 815 may be carried out by employing any combination of the six engines of the autonomic business process platform 110 based on the level of functionality needed as determined by the system, resource, user and process environment.

Sub-process ERP matching 820 may be a process of three way matching or two way matching between the invoice, purchase order and goods receipt note to identify data inaccuracy and/or inadequacy issues. The exception management process 825 may handle the data inadequacy and/or data inaccuracy issues identified during the processing of the invoice. The various attributes involved in the exception management process 825 include Enterprise Resource Planning (ERP) exception attributes, approver attributes, approval attributes, exception handling attributes, client exigency attributes, contract attributes, agent attributes, job attributes and job history. Payment management process 830 may handle payment of invoices while maximizing the benefits of availing discounts of early payments and avoiding penalties due to late payments. Furthermore, the sub-process ERP matching 820 may be carried out by employing any combination of the six engines of the autonomic business process platform 110 based on the level of functionality needed as determined by the system, resource, user and process environment.

Sub-process payment management 830 may be a process of authorizing the payments associated with the invoice and the vendor. For example, attributes associated with payment management 830 include payment attributes, mode of payment attributes, approver attributes, receiver details, contract details, client exigency attributes, bank attributes, method of output, output format, output details, payment history details and/or vendor history details. Furthermore, the sub-process payment management 830 may be carried out by employing any combination of the six engines of the autonomic business process platform 110 based on the level of functionality needed as determined by the system, resource, user and process environment.

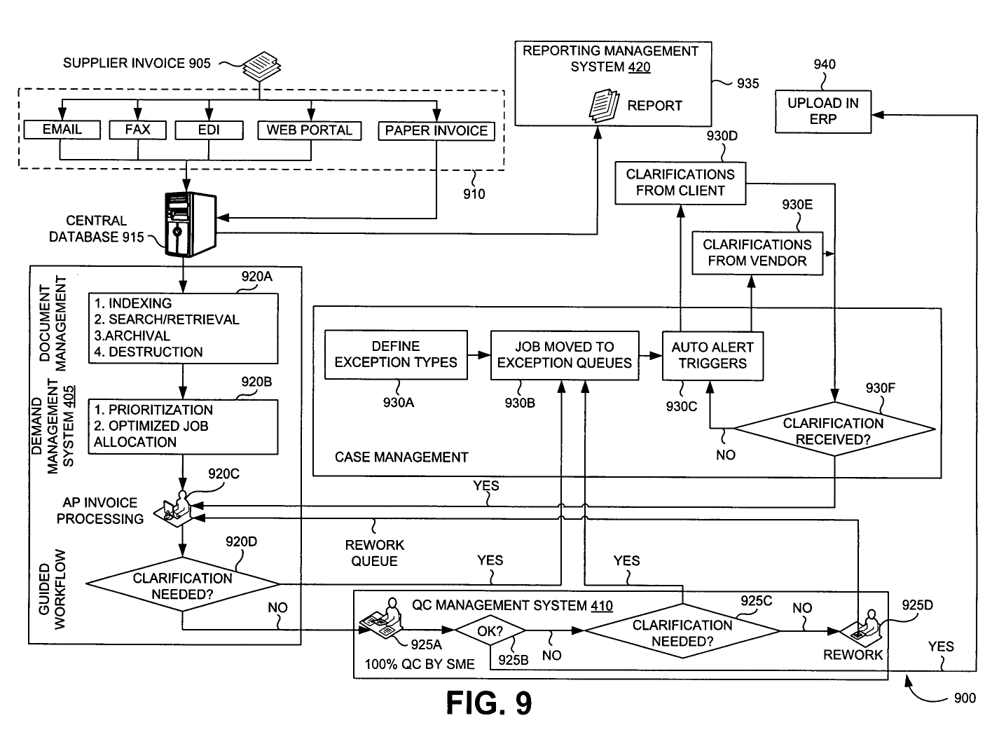

FIG. 9 illustrates a flow chart 900 representing functionality of the autonomic business process platform 110 in the account payable process, according to one embodiment. A supplier invoice 905 may include a record of transaction generated by suppliers requesting for payment of goods and/or services. For example, invoices for different vendors may be received by various methods. Methods of receipt of invoice 910 may include e-mail, fax, electronic data interchange (EDI), web portal, paper invoice, etc. A central database 915 may store the invoices from the suppliers, received through the various methods of receipt of invoice 910. For example, the central database 915 may include the physical invoices and invoices generated through electronic means (e.g., the invoices generated through email, web portal, fax, EDI, etc.).

In one embodiment, a reporting management system 420 generates reports using the invoice details stored in the central database 915 in operation 935. For example, the reports may include information about received invoices by age, data on invoices from different vendors, discounts offered by different vendors, etc. In another embodiment, the process of invoice validation 810 may be performed on the received invoices. In operation 920A, functions such as indexing, search or retrieval, archival, destruction (e.g., of undisputed invoices, aged five years) of invoices stored in the central database 915, etc., are performed (e.g., by the document management system). In operation 920B, functions such as prioritization, optimized job allocation, etc. are performed (e.g., by the demand management system 405 of FIG. 4).

Further, the invoices that are indexed and prioritized are processed in operation 920C. In operation 920D, it is determined whether or not any clarification of the invoice is required. If it is determined that clarification is required in operation 920D, then the process 900 goes to operation 930B to move the job to exception queues. In operation 920D, if it is determined that no clarification is needed, then the process 900 goes to operation 925A where 100% quality control of the invoices are carried out and in operation 925B, a verification is made whether the invoices are in 100% compliance with prescribed requirements set forth by subject matter expert (SME) with the process. If it is determined that quality check (QC) has been met with the prescribed requirements, then the process 900 goes to operation 940, where the invoices are uploaded in ERP.

If not, the process 900 goes to operation 925C where it is determined whether or not any more clarification of the invoice is needed. In operation 925D, the job is moved to rework queue and then to operation 920C for accounts payable (AP) invoice processing if it is determined that no clarification is needed in operation 925C.

In operation 925C, if it is determined that the clarification is needed from the clients, then the job is moved to exception queues, wherein types of jobs that qualify as exceptions are pre-defined in operation 930A. In operation 930C, auto alerts are triggered seeking clarifications from the clients in operation 930D and clarifications from vendors in operation 930E. In operation 930F, it is determined whether or not clarifications are received from the clients and/or the vendors. The operation 930C is repeated to trigger auto emails if it is determined in operation 930F that no clarifications are received from the clients and/or the vendors. If clarifications are received from the client and/or the vendors, then the process 900 goes to operation 920C to process the AP invoice. The process 900 then repeats other operations to index the invoice and upload the invoice in ERP in order to complete the accounts payable functionality.

For example, as illustrated in FIG. 9, the quality management system 410 performs the operations 925A-D, the case management system 425 performs the operations 930A-D, and the reporting management system 420 performs the operation 935 to complete the accounts payable functionality at the process level. Further, each management operation may employ the autonomic business process platform 110 to perform the above-mentioned operations which are functionalities enabled by the autonomic business platform 110 at the meta-process level, thereby completing the account payable functionality efficiently at the process level.

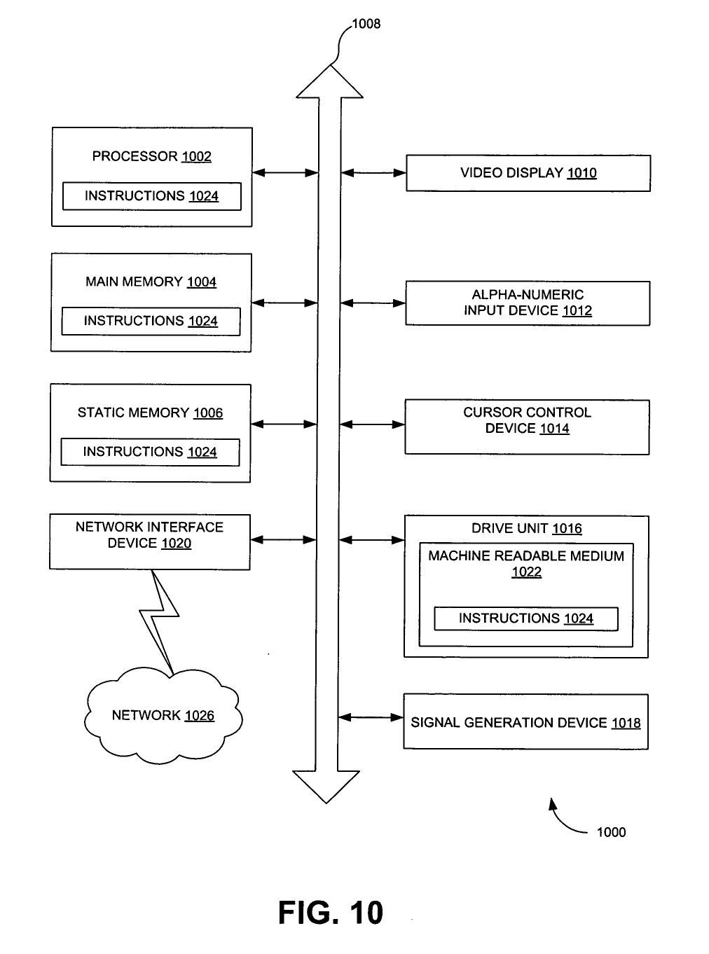

FIG. 10 illustrates a diagrammatic system view 1000 of a data processing system in which any of the embodiments disclosed herein may be performed, according to one embodiment. Particularly, the diagrammatic system view of FIG. 10 illustrates a processor 1002, a main memory 1004, a static memory 1006, a bus 1008, a video display 1010, an alpha-numeric input device 1012, a cursor control device 1014, a drive unit 1016, a signal generation device 1018, a network interface device 1020, a machine readable medium 1022, instructions 1024 and a network 1026.

The diagrammatic system view 1000 may indicate a personal computer and/or a data processing system in which one or more operations disclosed herein are performed. The processor 1002 may be a microprocessor, a state machine, an application specific integrated circuit, a field programmable gate array, etc. The main memory 1004 may be a dynamic random access memory and/or a primary memory of a computer system. The static memory 1006 may be a hard drive, a flash drive, and/or other memory information associated with the data processing system.

The bus 1008 may be an inter-connection between various circuits and/or structures of the data processing system. The video display 1010 may provide graphical representation of information on the data processing system. The alpha-numeric input device 1012 may be a keypad, keyboard and/or any other input device of text (e.g., a special device to aid the physically handicapped). The cursor control device 1014 may be a pointing device such as a mouse. The drive unit 1016 may be a hard drive, a storage system, and/or other longer term storage subsystem.

The signal generation device 1018 may be a bios and/or a functional operating system of the data processing system. The network interface device 1020 may perform interface functions (e.g., code conversion, protocol conversion, and/or buffering) required for communications to and from the network 1026 between a number of independent devices (e.g., of varying protocols). The machine readable medium 1022 may provide instructions on which any of the methods disclosed herein may be performed. The instructions 1024 may provide source code and/or data code to the processor 1002 to enable any one or more operations disclosed herein.

The above-described method may be in a form of a machine-readable medium embodying a set of instructions that, when executed by a machine, causes the machine to perform any method disclosed herein. It will be appreciated that the various embodiments discussed herein may not be the same embodiment, and may be grouped into various other embodiments not explicitly disclosed herein.

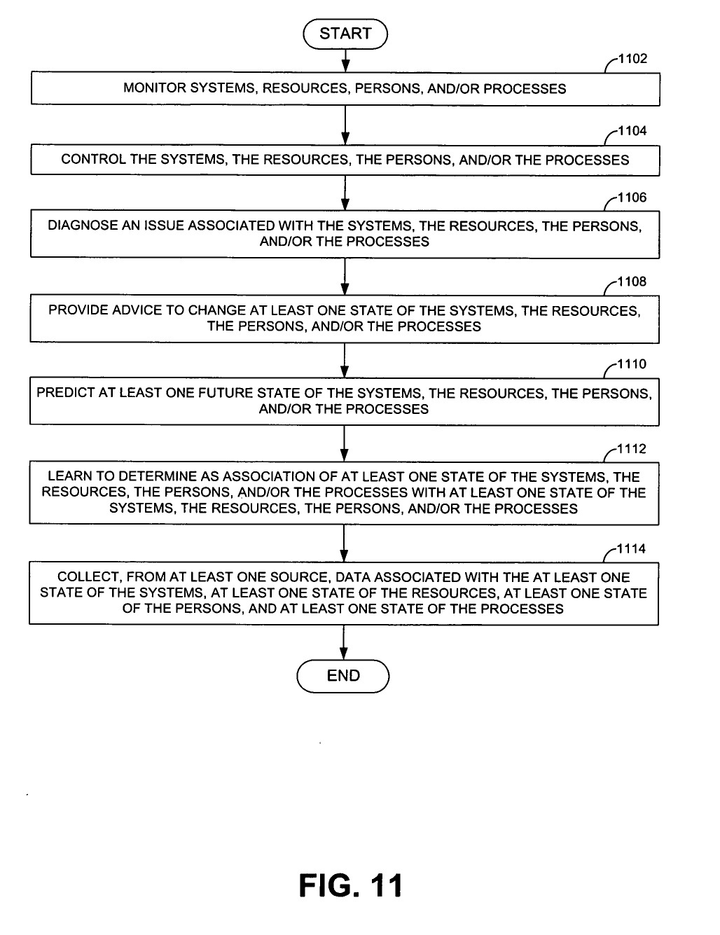

FIG. 11 illustrates a process flow of generating an autonomic business process platform 110, according to embodiment. In operation 1102, systems, resources, persons, and/or processes may be monitored (e.g., through the monitoring engine 140 of FIG. 1). In operation 1104, the systems, the resources, the persons, and/or the processes may be controlled (e.g., using the controlling engine 150 of FIG. 1).

In operation 1106, an issue associated with the systems, the resources, the persons, and/or the processes may be diagnosed (e.g., using the diagnosing engine 145 of FIG. 1). In operation 1108, advice to change at least one state of the systems, the resources, the persons, and/or the processes may be provided (e.g., through diagnosing engine 145 of FIG. 1).

In operation 1110, at least one future state of the systems, the resources, the persons, and/or the processes may be predicted (e.g., using the predicting engine 160 of FIG. 1). In operation 1112, determination of an association of at least one state of the systems, the resources, the persons, and/or the processes with at least one state of the systems, the resources, the persons, and/or the processes may be learnt (e.g., using the learning engine 155 of FIG. 1).

In operation 1114, data associated with at least one state of the systems, at least one state of the resources, at least one state of the persons and at least one state of the processes may be collected (e.g., using the collecting engine 135 of FIG. 1) from at least one source.

In some embodiments, the process is associated with multiple monitoring, execution, and/or management systems. For example, the monitoring, execution, and/or management systems include the demand management system 405, the QC management system 410, the SLA management system 415, and the reporting management system 420.

The above-described method may enable business processes to become scalable, automatic, and repeatable. The above-described method may require no human intervention thereby making business processes cost efficient. Also, the above-described method may enable processes to become repetitive in terms of outcomes. In addition, the above-described platform may provide lean operations to eliminate waste and to create value.

Further, the above-described platform may enable faster transitions and stabilization of processes through automating onboarding, running and managing part of an operation. The above-described platform may ensure alignment of business goals to processes operation though providing dashboards, drill down reports, and real time alerts thereby providing complete transparency in the business process operations. In addition, the above-described framework may allow better business process engineering as prediction of future outcomes through simulation of process behavior is achieved.

Although the present embodiments have been described with reference to specific example embodiments, it will be evident that various modifications and changes may be made to these embodiments without departing from the broader spirit and scope of the various embodiments. For example, the various devices, engines, analyzers, generators, etc. described herein may be enabled and operated using hardware circuitry (e.g., CMOS based logic circuitry), firmware, software and/or any combination of hardware, firmware, and/or software (e.g., embodied in a machine readable medium).

For example, the various electrical structure and methods may be embodied using transistors, logic gates, and electrical circuits (e.g., Application Specific Integrated Circuitry (ASIC) and/or in Digital Signal Processor (DSP) circuitry).

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A method comprising:
monitoring at least one of at least one system, at least one resource, at least one person, and at least one process; and
controlling the at least one system, the at least one resource, the at least one person, and the at least one process.

2. The method of claim 1, further comprising:
diagnosing, an issue associated with the at least one system, the at least one resource, the at least one person, and the at least one process; and
providing advice to change at least one state of the at least one system, the at least one resource, the at least one person, and the at least one process.

3. The method of claim 1, further comprising:
predicting at least one future state of the at least one system, the at least one resource, the at least one person, and the at least one process.

4. The method of claim 1, further comprising:
learning to determine an association of at least one state of the at least one system, the at least one resource, the at least one person, and the at least one process with at least one state of the at least one system, the at least one resource, the at least one person, and the at least one process.

5. The method of claim 1, further comprising:
collecting, from at least one source, data associated with at least one state of at least one system, at least one state of the at least one resource, at least one state of the at least one person, and at least one state of the at least one process.

6. A method, comprising:
monitoring at least one of at least one system, at least one resource, at least one person, and at least one process;
controlling, the at least one system, the at least one resource, the at least one person, and the at least one process;
diagnosing, an issue associated with the at least one system, the at least one resource, the at least one person, and the at least one process;
providing advice to change at least one state of the at least one system, the at least one resource, the at least one person, and the at least one process;
predicting at least one future state of the at least one system, the at least one resource, the at least one person, and the at least one process; and
learning to determine an association of at least one state of the at least one system, the at least one resource, the at least one person, and the at least one process with at least one state of the at least one system, the at least one resource, the at least one person, and the at least one process.

7. The method of claim 6, further comprising:
collecting, from at least one source, data associated with at least one state of the at least one system, at least one state of the at least one resource, at least one state of the at least one person, and at least one state of the at least one process.

8. The method of claim 6, wherein the method is associated with at least one of multiple monitoring, execution, and management systems.

9. The method of claim 1 in a form of a machine-readable medium embodying a set of instructions that, when executed by a machine, causes the machine to perform the method of claim 1.

10. A system, comprising:
a monitoring engine to monitor at least one of at least one system, at least one resource, at least one person, and at least one process; and
a controlling engine to control the at least one system, the at least one resource, the at least one person, and the at least one process.

11. The system of claim 10, further comprising:
a diagnosing engine to diagnose an issue associated with the at least one system, the at least one resource, the at least one person, and the at least one process and to provide advice to change at least one state of the at least one system, the at least one resource, the at least one person, and the at least one process.

12. The system of claim 10, further comprising:
a predicting engine to predict at least one future state of the at least one system, the at least one resource, the at least one person, and the at least one process.

13. The system of claim 10, further comprising:
a learning engine to learn to determine an association of at least one state of the at least one system, the at least one resource, the at least one person, and the at least one process with at least one state of the at least one system, the at least one resource, the at least one person, and the at least one process.

14. The system of claim 10, further comprising:
collecting engine to collect, from at least one source, data associated with at least one state of the at least one system, at least one state of the at least one resource, at least one state of the at least one person, and at least one state of the at least one process.

15. A system, comprising:
a monitoring engine to monitor at least one of at least one system, at least one resource, at least one person, and at least one process;
a controlling engine to control the at least one system, the at least one resource, the at least one person, and the at least one process;
a diagnosing engine to diagnose an issue associated with the at least one system, the at least one resource, the at least one person, and the at least one process and to provide advice to change at least one state of the at least one system, the at least one resource, the at least one person, and the at least one process;
a predicting engine to predict at least one future state of the at least one system, the at least one resource, the at least one person, and the at least one process; and
a learning engine to learn to determine an association of at least one state of the at least one system, the at least one resource, the at least one person, and the at least one process with at least one state of the at least one system, the at least one resource, the at least one person, and the at least one process.

16. The system of claim 15, further comprising:
collecting engine to collect, from at least one source, data associated with at least one state of the at least one system, at least one state of the at least one resource, at least one state of the at least one person, and at least one state of the at least one process.

17. The system of claim 15, wherein the system is associated with at least one of multiple monitoring, execution, and management systems.

18. An autonomic business process platform, comprising:
a first instruction to monitor at least one of at least one system, at least one resource, at least one person, and at least one process;
a second instruction set integrated with the first instruction set to control the at least one system, the at least one resource, the at least one person, and the at least one process;
a third instruction set integrated with the first instruction set and the second instruction set to diagnose an issue associated with the at least one system, the at least one resource, the at least one person, and the at least one process and to provide advice to change at least one state of the at least one system, the at least one resource, the at least one person, and the at least one process;
a fourth instruction set integrated with the first instruction set, the second instruction set, and the third instruction set to predict at least one future state of the at least one system, the at least one resource, the at least one person, and the at least one process; and
a fifth instruction set integrated with the first instruction set, the second instruction set, the third instruction set, and the fourth instruction set to learn to determine an association of at least one state of the at least one system, the at least one resource, the at least one person, and the at least one process with at least one state of the at least one system, the at least one resource, the at least one person, and the at least one process.

19. The autonomic business process platform of claim 18, further comprising:
a sixth instruction set integrated with the first instruction set, the second instruction set, the third instruction set, the fourth instruction set, and the fifth instruction set to collect, from at least one source, data associated with at least one state of the at least one system, at least one state of the at least one resource, at least one state of the at least one person, and at least one state of the at least one process.

20. The autonomic business process platform of claim 18, wherein the autonomic business process platform is associated with at least one of multiple monitoring, execution, and management systems.
